(19) United States
(12) Patent Application Publication
(10) Pub. No.: US 2026/0339979 A1
(43) Pub. Date: Oct. 29, 2026

(54) TOKENIZATION OF DATA FOR USE IN AI APPLICATIONS

(71) Applicant: Formic Al Ltd., Toronto (CA)

(72) Inventors: Varun Ranganathan, Bangalore (IN); Benjamin Christie, Toronto (CA)

(21) Appl. No.: 19/107,405

(22) PCT Filed: Sep. 7, 2023
(86) PCT No.: PCT/CA2023/051183

§ 371 Date: Feb. 27, 2025

Related U.S. Application Data
(60) Provisional application No. 63/404,458, filed on Sep. 7, 2022.
(60) Provisional application No. 63/409,877, filed on Sep. 26, 2022.

(51) Int. Cl. G06F 16/28; G06F 16/901

(52) U.S. Cl. CPC G06F 16/285; G06F 16/9024

(57) ABSTRACT

Systems and methods relating to the tokenization of data from a corpus of data. Subsets or collections of data from the corpus are retrieved and are recursively decomposed into the smallest unit of data for the data type, with each step in the decomposition generating at least one token. The generated tokens are stored as nodes in a sub-tree and parameters are determined for each token. The sub-tree may be implemented as a graph and may be stored in a database of graphs. The sub-tree may be optimized using various processes. The sub-tree is then incorporated into a larger tree. Implementation involves multiple execution units operating simultaneously in parallel with a coordination unit ensuring that data issues between sub-trees are addressed prior to storing or incorporating the sub-trees into the larger tree.

### TECHNICAL FIELD

The present invention relates to data processing and data structures. More specifically, the present invention relates to systems and methods for encoding, storing, and using a corpus of data with both AI-based and non-AI based methods.

### BACKGROUND

Artificial Intelligence (AI) is a branch of computer science that deals with algorithms which seek to simulate human cognitive abilities in a machine. The core of AI-powered systems are algorithms that make predictions about certain aspects of its environment, using techniques ranging from simple rule-based procedures to complex statistics-based machine learning. AI-based algorithms are generally utilized in two scenarios:
i) where it is extremely hard to gather all information required to perform a task ; and
ii) where the computational burden is too high to solve a task, even if all the informational pieces required are available.

Using AI in these situations can provide efficient solutions to complex problems.

In line with the two use-case scenarios for AI, from the 1950's to the early 2010's traditional AI methods were limited by the availability of computational resources and data. This resulted in algorithms being solved sufficiently through rule-based approaches. However, such approaches were extremely limited in scope relative to modern machine learning based approaches. Modern AI is driven by such statistics-based machine learning techniques, resulting in the analysis of large data sets in a finite duration of time. Such algorithms primarily perform actions that optimize for feedback generated by its environment. In this process of learning “an action”, machine learning models learn to mimic the data being inputted through generalized rules. Resulting from these actions, such models develop an intuition as to how the input(s) and output(s) are related. Then, unknown input(s) can be applied to the model, but only to perform a specific task. The handling of unknown input(s) allowed AI to set itself apart from traditional computer algorithms which require every scenario-action pair to be explicitly determined, either in code or in a database.

Today's approaches to AI are driven by deep learning, a subset of machine learning, specifically through large language modeling. The conceptual approach is two phased:
i) Use a large mathematical model and “pre-train” on a task that can be generally applied across a domain, such as natural language, vision, audio, or video. By learning to perform a generalized action across an informational modal, the model learns various general and specific representations. Given large amounts of data, an adequately parameterized model can learn generalized representations for the data pieces it has been trained on.
ii) After “pre-training”, the model is “fine-tuned” on a specific action and/or task. The specificity comes from either how the action is performed or the subset of data it is further trained on. The crux of this idea is to utilize the pre-trained model's generalized representations to uncover correlations within dataset pieces that are not explicit but could be inferred through an external knowledge base. This often leads to higher accuracies on development sets (i.e., the subset of the dataset used to validate the model).

Today's large language modeling techniques primarily depend on a mathematical model called “Transformers”. Almost all commercially successful and publicly popular language modeling techniques are built around the Transformer model. Often dubbed as a “foundational” model, Transformers have allowed computers to generate value from very large amounts (hundreds of gigabytes and even terabytes) of data. The value is generally found in the ability for a Transformer based system to understand and generate human language. Common examples of these systems are text-focussed systems such as GPT-3, BLOOM, GOPHER, or NLLB. Such systems have pushed the bounds of computers being able to complete many language-based tasks such as Sentiment Analysis, Summarization, Content Generation, etc. Use cases of this language-based technology can span across multiple industries or across any task that requires any sort of language analysis or generation. Common examples are machine translation, automatically written social media posts, entity extraction from complex contracts, and more. Furthermore, some organizations have begun applying Transformer based systems on image processing to allow computers to create their own image-based content (e.g., DALL-E 2).

With today's Transformer based approach to large language modeling comes with a number of disadvantages. As Transformer models do not model the temporal nature of a sequence, their primary flaws are very apparent in both commercial and academic settings. While Transformer based systems have been successful at reaching high accuracies on language-based tasks, one of their main flaws is that they require hard-coded or learnable position embeddings for each time step in the sequence, adding additional computational overhead.

Current techniques also have other issues. As an example, current machine learning techniques requires the practitioner to decide on a static computation graph, restricting the maximum number of features acceptable by the system. For example, today's commercial Transformers generally have a window of context of 2048, i.e., they can only accept and hold context within those 2048 input tokens.

Similarly, since deep learning partially involves compressing the dataset into a complex parameter space, it loses explainability. Biases that are present in data cannot be tracked back to the data pieces that induced the bias.

In addition, as pre-training corpuses consist of only “positive” examples of token sequences, “negative” examples need to be generated, implicitly or explicitly. This induces unexplainable biases, because models tend to learn spurious rules from negative examples, which are usually generated automatically on-the-fly.

Based on the above, there is therefore a need for systems and methods that mitigate, if not overcome the issues as noted above.

### SUMMARY

The present invention provides systems and methods relating to the tokenization of data from a corpus of data. Subsets or collections of data from the corpus are retrieved and are recursively decomposed with each step in the decomposition generating at least one token. The generated tokens are stored as nodes in a sub-tree and parameters are determined for each token. The sub-tree may be implemented as a graph and may be stored in a database of graphs. The sub-tree may be optimized using various processes. The sub-tree is then incorporated into a larger tree. Implementation involves multiple execution units operating simultaneously in parallel with a coordination unit ensuring that data issues between sub-trees are addressed prior to storing or incorporating the sub-trees into the larger tree.

In a first aspect, the present invention provides a method for encoding and storing data from a corpus of data, the method comprising:
a) retrieving a collection of data from said corpus of data;
b) recursively decomposing said collection of data into smaller and smaller sub-groups of data, wherein, for each sub-group of data that said collection of data is decomposed into, said sub-group is tokenized and a resulting token is stored in a node in a sub-tree along with multiple parameters relating to said resulting token;
c) repeating step b) until said collection of data has been decomposed into smallest units of data for a data type for said collection of data and until said smallest units of data have been tokenized and resulting tokens have been stored in said sub-tree;
d) adding said sub-tree resulting from said method to a larger tree.

In a second aspect, the present invention provides a method for processing tokens stored in a large tree data structure, the method comprising:
a) retrieving a sub-tree of said large tree data structure;
b) recursively processing tokens from nodes of said sub-tree such that relevant parameters for each token processed are also assessed;
c) repeating step b) until at least a majority of nodes in said sub-tree have been processed;
d) sending results of processing said tokens and said parameters to a coordination unit;
   wherein steps a)-d) are executed simultaneously in parallel by multiple execution units and wherein different ones of said multiple execution units process different sub-trees and wherein
   said method includes a step of coordinating between results received from said multiple execution units to thereby address potential data issues between results from said multiple execution units, said step of coordinating being executed by said coordination unit.

In another aspect, the method includes a step of applying at least one process that adds parameters for tokens in the sub-tree. The at least one process may include at least one of: forward propagation; back propagation; and back propagation through time.

The various methods of the present invention may be executed simultaneously in parallel by multiple execution units and different ones of the multiple execution units execute on different collections or different sub-trees of data. After execution, the execution results are coordinated between said multiple execution units to thereby avoid data issues between the results from the different multiple execution units. These data issues may include at least one of: data collisions; duplication of indices used by said tokens; and inconsistencies between output data generated by different execution units.

One or more of the multiple parameters for the tokens may be related to a lineage or an ancestry (where the token comes from) or to descendant tokens of a token generated from a sub-group of said data.

The methods may include a step of storing the larger tree in a database of graphs. As well, the sub-tree can be stored in a data graph such that the tokens are stored as nodes in a directed graph.

The processing of the sub-trees may involve applying at least one trained machine learning model to at least one of the tokens in the sub-tree and to the parameters of the tokens. This processing may also involve adjusting parameters of tokens that have been processed. Furthermore, this processing may involve adding parameters to tokens that have been processed.

### BRIEF DESCRIPTION OF THE DRAWINGS

The embodiments of the present invention will now be described by reference to the following figures, in which identical reference numerals in different figures indicate identical elements and in which:

FIG. 1 is a flowchart detailing the steps in one aspect of the present invention;

FIG. 2 is another flowchart detailing the steps in a variant of the method illustrated in FIG. 1;

FIG. 3 is a block diagram of a system for implementing the method illustrated in FIG. 1; and

FIG. 4 is a block diagram of a system for processing sub-trees from a larger tree according to another aspect of the present invention.

### DETAILED DESCRIPTION

In one aspect, the present invention provides a system and a method for encoding and storing a corpus of data. In one aspect of the method, a collection or subset of the corpus of data is recursively decomposed and tokenized and the resulting tokens are stored in a tree data structure. The tree data structure can be implemented as a database of graphs. Parameters are generated for each resulting token and are stored with the relevant token. Once the subset of the corpus of data has been decomposed and the resulting tokens (and their parameters) are stored, the resulting tree is then added to a larger tree. For some implementations, this may involve adding the various tokens (stored as a graph) and their parameters to a relevant database.

Regarding each token's parameters, these parameters may be adjusted as necessary or may even be added to, depending on the system configuration. As an example, parameters may be adjusted or more parameters may be added every time an analysis of the tree is executed.

It should be clear that the decomposition of each collection of data is performed recursively and that each step of the decomposition generates one or more tokens. It should also be clear that a large corpus of data (which may include documents, images, video, or any number of types of data) can be encoded and stored by any number of execution units operating in parallel, with each execution unit processing a subset of the corpus of data. A coordinator processing unit may coordinate between the various execution units to ensure data integrity in the various sub-trees being generated prior to the sub-trees being grafted or incorporated into a larger tree.

The larger tree, once the corpus of data has been encoded and stored in multiple sub-trees and the sub-trees have been incorporated into the larger tree, can be analyzed and utilized using any number of tools to obtain useful result. As examples, the larger tree (implemented as a database of graphs) may be searched for specific content and analyzed and mined for useful conclusions. Each time the larger tree is analyzed or searched, the various parameters for the tokens may be adjusted or added to as detailed above.

In terms of searching and analysis of the larger tree, the larger tree can be quite large, especially as the tokens (stored as nodes in the tree) are generated for each step of the decomposition. To ensure that the searching and/or analysis are performed in finite and reasonable time, the larger tree may be divided into sub-trees and each sub-tree can be searched and/or analyzed by one or more execution units, with the one or more execution units operating in parallel. The results from these various execution units can then be sent to one or more corresponding coordination units that ensure that the results are consistent and suitable for the desired task.

It should also be clear that the resulting larger tree and the methods and systems of the present invention efficiently encode “extra” world knowledge, such as contextual understanding, localizations, and general knowledge. These can be encoded by way of the various parameters that may be generated for each token.

The use of a token based tree structure allows for the systems and methods of the present invention to seamlessly interoperate across distinct informational modals. In one aspect, it is preferred that at least one aspect of the present invention provides for a system that can accept unstructured natural language, images, audio, video along with structured data residing in databases.

As noted above, the search and/or analysis (as well as the generation) of the larger tree can be executed using multiple execution units operating in parallel. Preferably, the various execution units are operating in parallel independently of one another so that the benefits of true parallel execution can be taken advantage of. This allows for the systems of the present invention to be run in a computationally affordable environment. Affordability is directly related to the ability for a system to be pre-trained, fine-tuned, and inferred at a fractional efficiency in comparison to transformer-based solutions.

In another aspect, the present invention provides for a system that is not restricted by the static computational graphs, thereby allowing the user to input information of any length while having the system hold context throughout the entirety of the input.

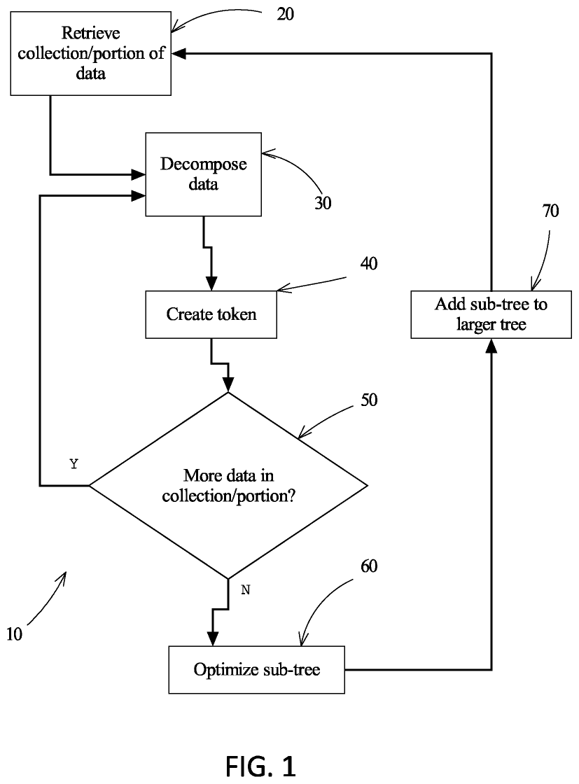

Referring to FIG. 1, a flowchart 10 of a method according to one aspect of the present invention is illustrated. As can be seen, the first step 20 of the method is that of retrieving a collection of data from a larger corpus of data. This collection of data, which may be comprised of documents, images, unstructured or structured data, or any mixture of types of data, is retrieved from the corpus of data. A portion of that collection of data is then separated from the collection and the portion is to be processed. In the event the collection of data is a mixture of various data types, the data type of the portion of data is determined and suitable parameters an configurations for the execution unit are adjusted for the specific data type being processed.

Once the data type has been determined for the portion to be processed, that portion is then decomposed (step 30). Tokens from the decomposition are then created (step 40) and suitable parameters for these created tokens are determined and the tokens are stored in nodes in a sub-tree. If there is more data in the portion to be decomposed (decision 50), then the logic flow returns to step 30 as the portion of data is recursively decomposed until the portion has been decomposed into the smallest units of data for that data type. Of course, each step in the decomposition generates one or more tokens and these tokens are stored in the nodes of the sub-tree and their relevant parameters are stored as well.

After the portion of data has been decomposed into the smallest units of data for that data type, another portion of the collection of data can be retrieved and steps 30-50 can be repeated for each portion of data until the collection of data from the corpus has been encoded and stored in a resulting sub-tree. Once the collection of data has been encoded into a sub-tree, one optional step is to optimize the resulting sub-tree generated (step 60). Optimizing the sub-tree is optional but may assist in the efficient processing of the sub-tree when the nodes in the sub-tree and their parameters are being searched and/or analyzed. This optional optimization step is explained in more detail below.

In the event that the optional optimization step is skipped or after the optimization step has been executed, the resulting sub-tree is then grafted on to the larger tree. In practical terms this means that the data generated for the sub-tree is merged into the larger database (step 70). Of course, after the sub-tree has been merged into the larger tree, the execution unit executing the method can repeat the method with a new collection of data from the corpus of data.

Regarding the decomposition of the portion of data, as noted above, each step in the decomposition generates one or more tokens. As well, as noted above, the decomposition continues until the portion is decomposed into the smallest unit of data for that data type. As an example, if the portion of data to be decomposed is text data, then the smallest unit of data is that of a letter. If the original portion is a sentence, then the sentence generates a token and the decomposition generates multiple tokes as each word and phrase in the sentence is decomposed. As an example, if the sentence to be decomposed is “This is a sentence” then this sentence generates one token for the original sentence. The sentence also generates tokens for the following words and phrases and these are detailed in the following decomposition steps:
step 1 (Decompose by removing the left most word and create two tokens—one for the removed word and one for the remaining words)
   TOKEN: This
   TOKEN: is a sentence
step 2 (continue and repeat from the remaining words)
   TOKEN: is
   TOKEN: a sentence
step 3 (continue and repeat from the remaining words)
   TOKEN: a
   TOKEN: sentence
step 4 (Decompose by removing the right most word and create two tokens—one for the removed word and one for the remaining words)
   TOKEN: sentence
   TOKEN: This is a
step 5 (continue and repeat from the remaining words)
   TOKEN: a
   TOKEN: This is
step 6 (continue and repeat from the remaining words)
   TOKEN: is
   TOKEN: This
step 7 (Decompose each word and generate one token per letter from the word) (tokens omitted)

As can be seen, the successive removal of one word per step from the sentence may generate multiple tokens per step. Steps 1-3 removes a left most word from the sentence/phrase and the process continues until no words are left. Steps 4-6 removes a rightmost word from the sentence/phrase and the process continues until no words are left. Step 7 decomposes each word in the sentence into its constituent letters. Each letter generates a token.

From the above, it can be seen that some tokens may seem to be duplicates of others. However, since each token is generated at a different time step (i.e. each token's parent tokens tend to be different even if the token is the same), these tokens are different. As an example, the token “a” in step 5 is different from the token “a” in step 3 as each are generated from different phrases (i.e. the parentage is different). Similarly, the token for the letter “i” from the word “is” is a different token from the token for the letter “i” from the word “is”. However, the 3 tokens for the letter “e” from the word “sentence” may be, depending on the implementation, considered to be redundant and may be removed in an optimizing step.

For clarity, parameters for the various tokens may indicate the parentage and/or genealogy and/or ancestry of a token. As an example, the token for “is” may have parameters detailing that it has two child tokens (for the letters “i” and “s”) and may include parameters detailing that the token derives from the token for the phrase “This is” and from the token for the original sentence “This is a sentence”. Such parameters allow for execution units to trace a token's sources as well as a token's offspring. Of course, if the implementation only allows for a one-way directed graph implementation, then the parameters may only indicate a token's offspring (i.e. which tokens derive from the current token). Similarly, a token's parameters may not simply identify that token's offspring but how many tokens derive from that original token.

It should also be clear that each original collection of data generates its own first token prior to being decomposed and that the corpus of data generates its own original token. For a corpus of data that is comprised of text data, each subset of that corpus (whether that subset is a section, a chapter, a paragraph, a sentence, a phrase, etc., etc.) can generate its own subtree and that the union of all those subtrees results in the large tree that encodes the whole corpus. For other types of data, such as digital images, digital audio files, digital video files, other subsets may, of course, be used. As an example, for digital images, the subset may be a digital image and that subset can be decomposed into sections of that digital image. For such a data type, the smallest unit of data may be a pixel and the parameters for the various subsets (e.g. for a section of the digital image) may include image characteristics of the subset such as hue, brightness, color, palette used, etc., etc.

As can be imagined, given that each token can have many parameters (some detailing genealogy, some being identifying indices, while other parameters may detail other characteristics of the token), each token may have many parameters. For some implementations, tokens may have dozens if not hundreds of parameters and these parameters may be added to or may be adjusted by processes that analyze and/or search through the tokens.

From the above, it was noted that an optional step may be the optimization of a sub-tree prior to its inclusion into the larger tree. Optimization may take the form of removing or minimizing duplicate tokens. As an example, the 3 tokens for the letter “e” from the word “sentence” in the example above may be optimized so that only one token is used in the sub-tree. The other two tokens for the same letter (and which should have identical parameters) may be removed for optimization purposes.

Optimization may also take the form of applying forward propagation and/or backpropagation processes to the sub-tree. Such processes would adjust at least some of the parameters of the various tokens and may even add parameters to the tokens. As well, backpropagation through time may also be applied to the sub-tree. Backpropagation through time is a well-known technique used in AI applications. The various propagation techniques are discussed and described later in this document.

It should be clear that other optimization methods and processes may be applied to the sub-tree to ensure that the sub-tree nodes are optimized in terms of number of nodes, organization of nodes, and to ensure that the sub-tree is easier to traverse/use.

Once the sub-tree has been optimized, it can then be incorporated into the larger tree.

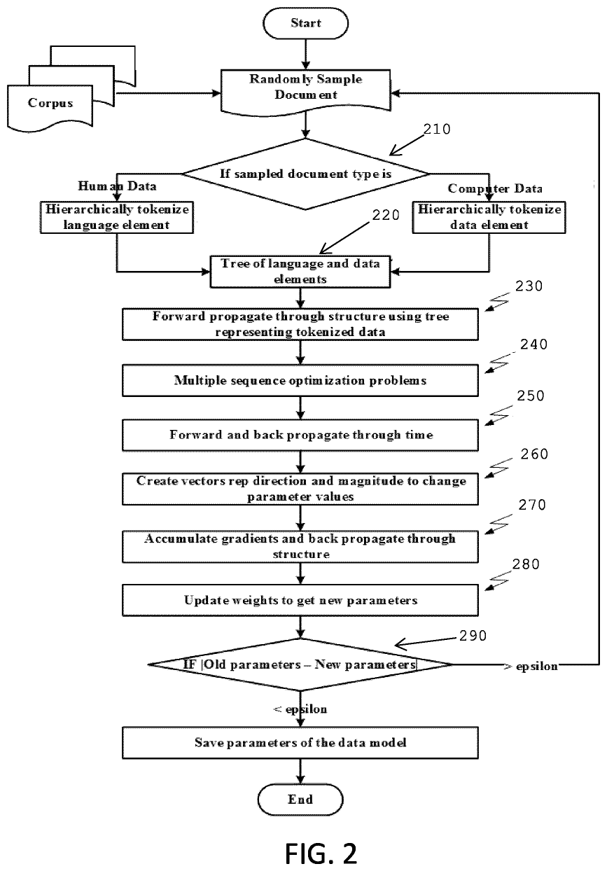

Referring to FIG. 2, a flowchart for another embodiment of the present invention is provided. As can be seen, the process illustrated in FIG. 2 is a more detailed version of the process shown in FIG. 1. In FIG. 2, the collection of data from the corpus of data may be a language element or a data element and step 210 is that of determining the data type of the data prior to decomposing that data for tokenization and storage. Once the data type has been determined, the generated token is stored in the sub-tree (step 220). In this process, the sub-tree is optimized after every node is added. As can be seen, steps 230-280 apply various optimization processes to the sub-tree and adjusts/adds parameters for the various nodes in the sub-tree. In step 290 the difference between the newly generated parameters and the old parameters is determined and, if the difference is smaller than a predetermined value (e.g. a value “epsilon”) then the changes to the sub-tree (and to the parameters) are committed to the larger tree/database. It should be clear that, if the difference between the new parameters and the old parameters are larger than the predetermined values, then the optimizations are working (i.e. the differences are noticeable between the old and the new parameters) and the further optimizations (and data additions) can still be performed. Once the differences are less than the selected threshold value, then the last round of optimizations has not produced a significant amount of difference (i.e., the optimizations have not been too effective).

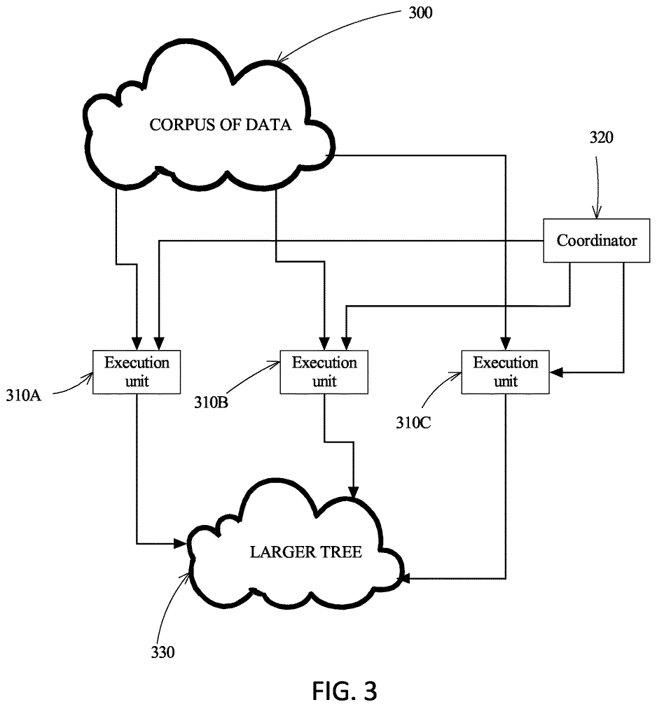

In terms of implementation, FIG. 3 schematically illustrates a system that can be used to encode and store a corpus of data. As can be seen from the figure, a corpus 300 of data is to be encoded (tokenized) and stored. Multiple execution units 310A, 310B, 310C, 310D each receive a different portion or collection of unencoded data from the corpus 300. Each execution unit creates a sub-tree of tokens from its portion or collection of unencoded data by executing/implementing the method detailed in FIG. 1.

Once each execution unit has produced its sub-tree (and, preferably, that sub-tree has been optimized), the sub-tree and its parameters are coordinated across the various execution unit results using a coordination unit 320. The coordination unit ensures that there is coordination between the various resulting sub-trees and ensures that there are no conflicting indices, conflicting data, conflicting nodes, etc. across the various sub-trees. Any conflicts are resolved by the coordination unit 320 and, after the coordination has been performed, the sub-trees are grafted on to or incorporated with the larger tree 330.

It should be clear that the various execution units are operating in parallel to and independent of one another. It should also be clear that, while the various execution units operate in parallel, the various resulting sub-trees from the execution units are operated on in a sequential manner by the coordination unit. As such, when possible, the system operates/executes the method of the present invention in parallel and, when not possible or when impractical, the method is operated in sequence. Thus, the resulting sub-trees are coordinated against other sub-trees in sequence as, for example, data collisions between indices of different sub-trees are possible.

For clarity, while FIG. 3 only illustrates 3 execution units, the concept may be extended to any number of execution units. Also, while a single coordination unit is illustrated, multiple coordination units are possible as long as these coordination units coordinate possible data collisions and data issues with one another. In terms of implementation, the system in FIG. 3 may be implemented using any number of online or cloud computing platforms, with each execution unit being one or more clusters of processing units that are operating in parallel. Similarly, the coordination unit may be any number of processing units that operate in sequence or in coordinating with one another. Storage of the resulting larger tree, perhaps implemented as a database of graphs, could also be implemented by way of a cloud computing storage platform.

Once the larger tree has been created and the various sub-trees have been optimized, the resulting overall tree (implemented as a database of graphs with the various sub-trees being implemented as graphs and the larger tree being implemented as a large graph of nodes and edges stored in a database) can be used for searching and analysis of the corpus stored in the larger tree.

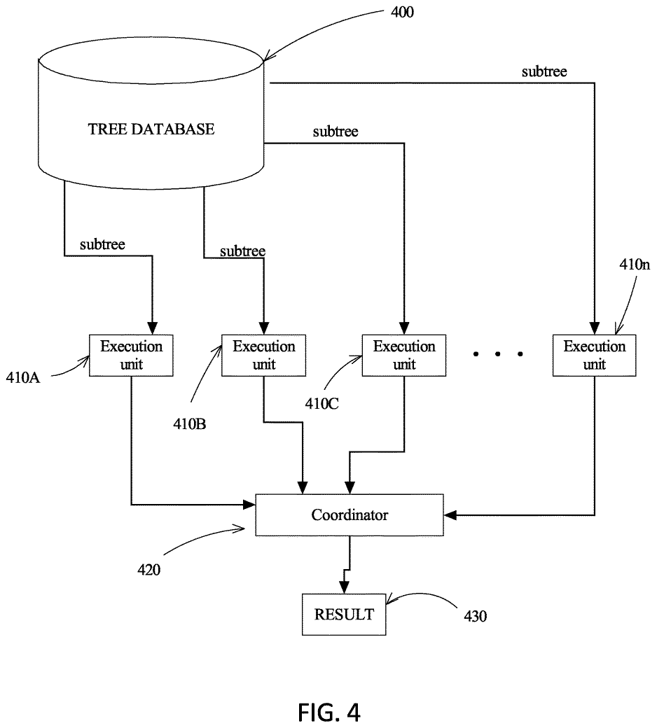

To implement searching and/or analysis of the larger tree in execution time that is reasonable, an approach similar to that used for the encoding of the corpus of documents may be used. To this end, FIG. 4 illustrates a block diagram of a system which may be used to process the resulting larger tree (or its implementation as a database of graphs) when searching and/or analyzing the at least a portion of the larger tree.

Referring to FIG. 4, the block diagram illustrates a system for searching and/or analyzing the tokenized corpus of data. As can be seen, the database 400 of graphs stores the larger trees and each of the various execution units 410A, 410B, 410C, . . . 410n receives a sub-tree that is a subset of the larger tree. Preferably, each sub-tree is independent of the other sub-trees and, as such, each of the execution units can operated in parallel and independent of the other execution units.

Once each of the various sub-trees has been searched/analyzed, the results from each of the sub-trees are sent to a coordinator unit 420. The coordinator unit coordinates between the various results and removes duplicates, redundancy, and ensures that the final results 430 are internally consistent. As well, the coordinator unit ensures that the results are in-line with or are consistent with the query/task. (As an example, if the initial query is for the number of instances of a specific term or of versions of that specific term in a library of documents, the coordinator unit ensures that the counts from the various execution units are collated and that a sum is produced. For such a search, the coordinator unit may also ensure that the terms or versions of the terms being counted are internally consistent.)

It should be clear that the various execution units, when applying an analysis or a processing of the sub-tree it receives from the corpus of data, may be applying a trained model to the sub-tree. For each execution unit, such an analysis would result in analysis results for that unit's specific sub-tree. Once the application of the trained model is complete, the results would then be passed to the coordinator unit and the execution unit can receive a different sub-tree to which the same trained model is, again, applied.

It should also be clear that, after every analysis or after every search, the various parameters for the various tokens in the sub-trees may be adjusted/edited or added to. This ensures that the relationships between the various parameters and the various tokens in the sub-trees (and in the larger tree as a whole) are documented and/or detailed in the various parameters.

To better understand the intricacies of the various aspects of the present invention, a number of explanations and descriptions are provided below.

In AI, tokenization refers to splitting an entire text document into a sequence of smaller units, such as individual characters, sub-words, or words. Each of these smaller units are called tokens. In various implementations of the present invention, hierarchical tokenization is used. Hierarchical tokenization refers to splitting an entire text document into a structured-sequence or “tree” of smaller units, such as individual characters, sub-words, words, phrases, sentences, paragraphs, sections and the document itself. Each “smaller” unit is considered as a token. The root element represents the document, which is also considered as a token. In terms of implementation, tokenization is a process by which a piece of data is replaced by a surrogate value known as a token. The token can then be stored in a node in a graph or as an entry in a database.

Tokenization can be performed by using one or more of the many different known methods e.g. using Python's split( ) function, using Regular Expressions (RegEx) or using NLTK (Natural Language ToolKit) which is a library written in Python for symbolic and statistical Natural Language Processing.

In one embodiment of the present invention, a tree of language and data elements is created from the corpus of data. The tree could be represented by a graph, a superset of the function of trees. This is possible when nodes of the tree are linked to other database elements, creating a “graph”-like structure.

In terms of optimizing and/or determining parameters for the various tokens generated, this can be performed by forward propagating through the structure (i.e. through a sub-tree) that represents the tokenized data. This can be further implemented by creating/applying multiple sequence optimization processes to the sub-tree and then forward propagating again through the sub-tree. Further optimizations and further adjustments to the various parameters can be implemented by applying forward propagation and back propagation through time. Processes that create vectors that representing direction and magnitude of parameter changes can also be applied. These vectors can also be used to change parameter values if necessary or desired. Such vectors can be created using differentiation techniques such as gradient descent and its backpropagation extensions. Similarly, such vectors can be created using linear algebra solvers such as pseudo-inverse and its backpropagation extensions. As well, these vectors can be created using the directions of Lagrange multipliers and its backpropagation extension. Finally, genetic algorithms, which make best use of randomness, can also be used to generate these vectors.

Forward and back propagation can also be used for optimization. A learning algorithm/model finds out the parameters (weights and biases) with the help of forward propagation and backpropagation.

As is known, Backpropagation Through Time (BPTT) is the application of the Backpropagation training algorithm to Recurrent Neural Networks applied to sequence data (such as a time series) and is a gradient-based technique for training of Recurrent-style Neural Networks (RNN).

The goal of the backpropagation training algorithm is to modify the weights of a neural network in order to minimize the error of the network outputs compared to some expected output in response to corresponding inputs. It is a supervised learning algorithm that allows the network to be corrected with regard to the specific errors made. For the tree implementation, instead of modifying the weights of a neural network, the parameters of the various nodes in the sub-tree are modified.

For greater clarity, backpropagation, short for “backward propagation of errors,” is an algorithm for supervised learning of artificial neural networks using gradient descent. Given an artificial neural network and an error function, the method calculates the gradient of the error function with respect to the neural network's weights. Backpropagation assists in the fine-tuning the weights of a neural net based on the error rate (i.e. loss) obtained in the previous epoch (i.e. iteration). Proper tuning of the weights ensures lower error rates, making the model more reliable by increasing its generalization. For the present invention, instead of weights for a neural network, relevant parameters for the nodes in the sub-tree are adjusted. The gradient would be based on the changes in the parameters of various relevant nodes in the sub-tree.

Backpropagation through structure (BPTS) is a gradient-based technique for training Recursive Neural Nets (a superset of recurrent neural nets).

In forward propagation the input data is fed in the forward direction through the network or through the sub-tree. Each hidden layer accepts the input data, processes it as per the activation function and passes on to the successive layer. The feed-forward network helps in forward propagation.

To better understand the present invention, the following explanations are provided. A scalar quantity is simply a number and has only magnitude. A scalar can be designated a tensor of rank zero. A vector quantity has magnitude and direction. In two-dimensional space, for example, a vector has x-and y-components, and in a three-dimensional space, it has 3 components. Vectors can have any number of dimensions. These components are commonly shown in a one-dimensional column matrix. A vector can be designated a tensor of rank one. A tensor of rank two is represented by a matrix, while a rank-three tensor is represented with a cubic matrix. A tensor has 3 attributes: 1) rank or dimension: is the number of axes in a tensor 2) shape: is the number of elements along each axis and 3) data type: is the type of data contained in the tensor.

For a better understanding of the present invention, the following explanations are provided. A mathematical model may be used with the present invention. A mathematical model is a description of a system using mathematical concepts and language. It often involves an input which is operated upon with mathematical functions and additional parameters to produce an output.

In addition to a mathematical model, the concept of a data model may be used to explain the present invention. A data model describes a system that mimics the representation of data available to a system. A data model consists of: i) parameters for each recognized unit of natural language called “embedding parameters”, ii) parameters for all organizational storage hierarchies such as a drive, directory, folder, file, and/or datum called “auxiliary node parameters” and iii) a “composition function” which combines auxiliary and natural language units to form representations for bigger documents.

To explain the above, symbolic composition describes a function which inputs two representations of information (either partially or explicitly representing the input's properties), and returns a single output. The output is represented in the same representation space as the inputs, however it summarizes and consolidates the information contained within them.

In terms of data types which may be used with the present invention, human data may be used. Human data generally refers to data generated by humans or is about the humans. Human data is generally non-numerical unstructured data generated as a result of humans going about their everyday lives for example using a smartphone to send a text, while sending a tweet, while scheduling a meeting, while liking a photo, while buying a shirt, while paying for a coffee, while listening to music in a coffee shop on Wi-Fi in a location, filling online surveys, posting and interacting with social media e.g. liking photos or commenting on photos.

Similarly, computer data may also be used with the present invention. Computer data refers to data that is artificially generated by a computing system. For example, files and directories need to be uniquely identified using a URL-like sequence of characters. Similarly, webpages are Unique Resource Locators of files in an interconnected web of computing systems. To perform user verification processes, SSH, RSA and pub keys are used. Checksums are included in the data, which allows the computer to verify if the data acquired isn't corrupted.

The present invention provides a number of advantages. The resulting data structure of one aspect of the present invention may be used with a Large Language Model. The utility of a Large Language Model with the functional benefits of the data model structure of the present invention would enhance and expand the abilities of modern AI systems. Utilization of such a Large Language Model can improve capabilities in a variety of settings such as Search, Data Analysis, Content Generation, Encoding, and more. Such a technology may affect these various functions as follows:

Search: The data model may be used to efficiently sift through immense amounts of textual data will allow the present invention to surpass the capacity of current solutions on a number of different factors. Over a large corpus, the data model of the present invention will be able to accurately return contextual relevant material with minimal latency and computational resources. This allows the various aspects of the present invention to challenge existing search applications while creating opportunities to return more authentic results over larger corpuses.

Data Analysis: In one aspect of the present invention, the data model according to one aspect of the present invention is implemented as text-based information. This allows this text-based data model to be used with generalized data analysis. Relative to traditional AI, generalized data analysis in this context implies that the text-based data model of the present invention will not need to have a specific goal. The data model may be used to conduct a variety of functions to break down and analyze information, using the data model's pre-trained data as guidance in order to complete various tasks. These types of tasks can include anything from text analysis functions such as Relation Extraction or Part-of-Speech Tagging in addition to numerical analysis such as mathematical computation or functions of machine learning.

Content Generation: The data model resulting from the various aspects of the present invention will be able to generate and create content based on an inputted prompt. The parameters for the prompt can be specified to suit the user's needs for their individual situation. The content which is generated will be influenced by the information stored within the database used to implement the data model of the present invention. The data model does not need to be a direct copy of existing material. This implies that the data model will be able to be used to create content based on the model's unique perspective on how to break down a prompt.

Encoding: As a serveable utility of the model, data can be both encoded and decoded using a unique approach to ciphering. This allows the data model of the present invention to efficiently utilize the data passing through the system while also allowing the use of a method to structure information internally. The encoded data may be used for a variety of purposes such as the creation of high-level analyses of data organization or features. This can allow a user to get an idea of how schematic resemblance of the data prior to conducting deep-set analyses.

The system and method of the present invention, implemented as a Large Language Model, can be used for any combination of search, data analysis, content generation, encoding and similar functions for artificial intelligence.

In one implementation, implemented is a system and a method for encoding and storing a corpus of data. In this system and method, a collection or subset of the corpus of data is recursively decomposed and tokenized and the resulting tokens are stored in a tree data structure. The tree data structure is implemented as a database of graphs with the sub-trees being implemented as directed graphs. Parameters are generated for each resulting token and are stored with the relevant token. Once the subset of the corpus of data has been decomposed and the resulting tokens (and their parameters) are stored, the resulting tree is then added to a larger tree. For some implementations, this may involve adding the various tokens (stored as a graph) and their parameters to a database of graphs. Some of the parameters for the tokens detail each token's lineage (which tokens they derive from). Other parameters detail which tokens derive from the current token (descendant tokens).

After a sub-tree is created from a collection or a portion of data from the corpus of data, the sub-tree is optimized by applying different processes including any of: forward propagation, back propagation, back propagation through time, back propagation through the structure, optimization processes, parameter gradient determination processes, and gradient based optimization processes. A learning algorithm or process can be used to determine the parameters (weights and biases) of the various tokens and can be used in conjunction with forward and/or backward propagation.

The data in the collection of portion of data in this implementation may be image data, text data, human data, video data, audio data, structured data, or unstructured data. The tokenization of the decomposed data may be hierarchical tokenization and, for a text or language based corpus of data, the hierarchical tokenization includes splitting an entire text document into a sequence of smaller units, such as individual characters, sub-words, or words. Each of these smaller units is a token.

Hierarchical tokenization refers to splitting an entire text document into a structured-sequence or “tree” of smaller units, such as individual characters, sub-words, words, phrases, sentences, paragraphs, sections and the document itself. Each “smaller” unit is considered as a token in this implementation of the present invention. The root element of the sub-tree represents the document, which is also considered as a token.

The optimization processes adjusts and/or adds parameters to the tokens in the sub-tree prior to committing/storing the sub-tree. Once the difference between the old parameters and the new parameters is greater than a predetermined value, then the resulting sub-tree can be stored and/or committed and a new sub-tree can be started by retrieving a new collection or portion of data from the corpus of data.

The resulting large tree data model from the encoding and storage of the sub-trees can be used in place of a Large Language Model.

To tokenize a text based document, the process can use separate the document into paragraphs based on newline separators. Tokenization may use a specific sequence of characters. Paragraphs are then tokenized into sentences by finding full stops (i.e. periods) and a full stop can be used to break a paragraph into its constituent sentences. Since documents are composed of paragraphs and since paragraphs are composed of sentences, with sentences being composed of phrases and words, tokenization is implemented by separating the various parts into smaller components. Since words are composed of a sequence of characters separated by spaces, the words can be tokenized further into letters/characters. Document tokenization, in a text based collection of data, is achieved by using paragraph separators to divide a document into paragraphs, to divide paragraphs into sentences by finding a period or full stop. Sentences are then divided into words using word-boundaries. These word-boundaries can be found by finding text separated by two spaces. Words can then be separated into letters by dividing the letters in the word using the spaces between the letters.

The method can be implemented by using multiple execution units operating in parallel such that each execution unit tokenizes a different collection or portion of data from the other execution units. The sub-tree from each execution unit is sent to a coordination unit that removes duplicate tokens, prevents data collisions between sub-trees, and prevents reuse of indices used to index tokens in the sub-trees. After each sub-tree is processed by the coordination unit, the sub-tree is saved into a database of graphs, with the sub-tree being stored as a directed graph.

Each execution unit and each coordination unit can be a hardware or a software unit. For a software unit, the execution units operate independently of other execution units and are implemented using a cloud computing platform.

After the larger tree is complete, the resulting data model can be used for searching, data analysis, content generation, encoding/encryption and similar functions that are suitable for artificial intelligence.

To process the larger tree, multiple execution units each receive a sub-tree from the larger tree and process these sub-trees in parallel and independently of one another. The processing can be the application of a trained model to each sub-tree. Processing each sub-tree may adjust/add parameters for the tokens in the sub-tree.

After each sub-tree is processed by an execution unit, the results are sent to a coordination unit. The coordination unit harmonizes the different results from the different execution units so that the results are in-line with an original query and/or task. This means ensuring that the results are not conflicting, that the results are consistent (e.g. if the sought after results are numeric, that the results do not contain text or vice versa), and that the results are suitable for the query and/or task.

For processing the larger tree or the sub-trees from the larger tree, the execution units and the coordination unit can be hardware or software implementations. For a software implementation, the execution units operate independently of other execution units and are implemented using a cloud computing platform.

To assist in the analysis of parameters for the tokens, a recording function may be used. This recording function (termed as a “tape” function) may be used to record which operations are performed on different parameters. These operations record the compute graph created and the compute graph describes how various parameters interact with one other. For implementation, a tape could be represented using any memory location and the operations and intermediate outputs are stored using different memory locations as necessary. The word “tape” is used to refer to the recording of sequential operations and their intermediate outputs.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for encoding and storing data from a corpus of data, the method comprising:
a) retrieving a collection of data from said corpus of data;
b) recursively decomposing said collection of data into smaller and smaller sub-groups of data, wherein, for each sub-group of data that said collection of data is decomposed into, said sub-group is tokenized and a resulting token is stored in a node in a sub-tree along with multiple parameters relating to said resulting token;
c) repeating step b) until said collection of data has been decomposed into smallest units of data for a data type for said collection of data and until said smallest units of data have been tokenized and resulting tokens have been stored in said sub-tree;
d) adding said sub-tree resulting from said method to a larger tree.

2. The method according to claim 1 wherein said method includes a step of applying at least one process that adjusts parameters for tokens in said sub-tree, said at least one process including at least one of:
forward propagation;
back propagation;
back propagation through time.

3. The method according to claim 1 wherein said method includes a step of applying at least one process that adds parameters for tokens in said sub-tree, said at least one process including at least one of:
forward propagation;
back propagation;
back propagation through time.

4. The method according to claim 1 wherein said method is executed simultaneously in parallel by multiple execution units and wherein different ones of said multiple execution units execute said method on different collections of data.

5. The method according to claim 4 wherein said method includes a step of coordinating between said multiple execution units to thereby avoid data issues between said multiple execution units.

6. The method according to claim 5 wherein, for said step of coordinating between said multiple execution units to avoid data issues, said data issues include at least one of:
data collisions;
duplication of indices used by said tokens;
inconsistencies between output data generated by different execution units.

7. The method according to claim 1 wherein at least one of said multiple parameters is related to a lineage of a token generated from a sub-group of said data.

8. The method according to claim 1 wherein said method includes a step of storing said larger tree in a database of graphs.

9. The method according to claim 1 wherein said method includes a step of storing said sub-tree in a data graph such that said tokens are stored as nodes in a directed graph.

10. A method for processing tokens stored in a large tree data structure, the method comprising:
a) retrieving a sub-tree of said large tree data structure;
b) recursively processing tokens from nodes of said sub-tree such that relevant parameters for each token processed are also assessed;
c) repeating step b) until at least a majority of nodes in said sub-tree have been processed;
d) sending results of processing said tokens and said parameters to a coordination unit;
wherein steps a)-d) are executed simultaneously in parallel by multiple execution units and wherein different ones of said multiple execution units process different sub-trees and wherein
said method includes a step of coordinating between results received from said multiple execution units to thereby address potential data issues between results from said multiple execution units, said step of coordinating being executed by said coordination unit.

11. The method according to claim 10 wherein step b) comprises applying at least one trained machine learning model to at least one of said tokens and to said parameters of said tokens.

12. The method according to claim 10 wherein step b) comprises adjusting parameters of tokens that have been processed.

13. The method according to claim 10 wherein step b) comprises adding parameters to tokens that have been processed.

14. Non-transitory computer readable media having encoded thereon computer readable instructions that, when executed, implements a method for encoding and storing data from a corpus of data, the method comprising:
a) retrieving a collection of data from said corpus of data;
b) recursively decomposing said collection of data into smaller and smaller sub-groups of data, wherein, for each sub-group of data that said collection of data is decomposed into, said sub-group is tokenized and a resulting token is stored in a node in a sub-tree along with multiple parameters relating to said resulting token;
c) repeating step b) until said collection of data has been decomposed into smallest units of data for a data type for said collection of data and until said smallest units of data have been tokenized and resulting tokens have been stored in said sub-tree;
d) adding said sub-tree resulting from said method to a larger tree.

15. Non-transitory computer readable media having encoded thereon computer readable instructions that, when executed, implements a method for processing tokens stored in a large tree data structure, the method comprising:
a) retrieving a sub-tree of said large tree data structure;
b) recursively processing tokens from nodes of said sub-tree such that relevant parameters for each token processed are also assessed;
c) repeating step b) until at least a majority of nodes in said sub-tree have been processed;
d) sending results of processing said tokens and said parameters to a coordination unit;
wherein steps a)-d) are executed simultaneously in parallel by multiple execution units and wherein different ones of said multiple execution units process different sub-trees and wherein
said method includes a step of coordinating between results received from said multiple execution units to thereby address potential data issues between results from said multiple execution units, said step of coordinating being executed by said coordination unit.
